(19) United States
(12) Patent Application Publication
(10) Pub. No.: US 2013/0164516 A1
(43) Pub. Date: Jun. 27, 2013

(54) LOW TEMPERATURE SEALING FILMS

(71) Applicant: E I DU PONT DE NEMOURS AND COMPANY, Wilmington, DE (US)

(72) Inventors: KARLHEINZ HAUSMANN, Auvernier (CH); YVES M. TROUILHET, Vesenaz (CH); JUERGEN SCHIFFMANN, Hennef (DE)

(73) Assignee: E I DU PONT DE NEMOURS AND COMPANY, Wilmington, DE (US)

(21) Appl. No.: 13/717,872

(22) Filed: Dec. 18, 2012

Related U.S. Application Data
(60) Provisional application No. 61/579,137, filed on Dec. 22, 2011.

(51) Int. Cl. B32B 5/18; B32B 5/00

(52) U.S. Cl. CPC B32B 5/18; B32B 5/00
USPC 428/220; 428/339; 264/79

(57) ABSTRACT

Disclosed is a multilayer structure and a process therefore in which the multilayer structure comprises a core layer and a sealant layer; the structure is a coextruded, low temperature sealing, biaxially oriented film or sheet; the sealant layer has a seal initiation temperature of from 70 to 100° C.; the combined thickness of the core and the sealant layer is 20 to 60 μm; and the sealant layer has a thickness of from 10 to 20 percent based on the combined thickness of the core and sealant layer.

This application claims priority to U.S. provisional application 61/579137, filed Dec. 22, 2011; the entire disclosure of which is incorporated herein by reference.

The invention relates to coextruded, low temperature sealing (LTS), biaxially oriented multilayer film structures comprising a core layer and a LTS sealant layer, and which that can be used in packaging applications, in particular in food packaging applications

### BACKGROUND OF THE INVENTION

In the packaging industry, there is a constant demand for faster and more economical packaging solutions.

For example, biaxially oriented films based on polyethylene terephthalate or polypropylene, obtained by the tenter frame process, are very economical films for wrapping foodstuffs because of their excellent mechanical resistance and low thickness. These films, however, lack a sealing layer, and can therefore not be used for complex packaging applications unless a sealing layer is applied to them by either lamination or other deposition methods.

In a constant effort to increase the efficiency of packaging processes in the food industry, food producers have been aiming at increasing the speed, i.e. the number of packaged goods per time unit

A popular method for accelerating the packaging process consists in using so-called low temperature sealing resins in the sealing layer of packaging films. These resins allow for a lesser amount of thermal energy to be transferred from the sealing bars onto the sealing layer to form a seal and therefore reduce the sealing bar contact time needed to seal the package.

However, such low temperature sealing resins are specialty chemicals and their use is somewhat discouraged, based on their high cost, and more importantly, their use is discouraged based on the difficulties encountered in coextrusion of such resins. Due to the low temperature sealing ability, such resins start to stick, or glue, to the heated conveyor rolls usually used in a biaxial orientation process.

Therefore, in practice, multilayer films for packaging must use as little sealant resin as possible to keep the cost down, as well as be manufactured through cold spray coating the low temperature sealing resins onto a previously biaxially oriented film. A specific example of such a cold spray coating process is the use of an aqueous resin dispersion on biaxially oriented polypropylene films (boPP), for example in snack food packaging solutions.

Aqueous resin dispersions allow to deposit very small amounts of polymer onto a surface like for example a substrate film, by coating the surface with the dispersion and subsequently removing the solvent water by evaporation.

In snack food packaging solutions, a barrier substrate film such as polypropylene film is coated on one side with an aqueous dispersion of low temperature sealing resin. After removing the solvent water by drying, a thin layer of resin having a thickness of about 1 to 3 micrometers covers the surface of the substrate film and forms a sealing layer. Because the amount of applied sealant resin is small, the overall cost of a packaging film can be reduced accordingly.

In spite of the above-mentioned resin amount reduction, packaging films having a layer of sealant dispersed thereon have the disadvantage of being laborious in their manufacture. The manufacture of these films necessitates three separate steps which are a) the manufacture of the substrate films and b) the subsequent dispersion coating and c) drying step. The coating and drying steps represent a non-negligible part of the total cost of manufacture and it would therefore be desirable to eliminate said steps in order to obtain less costly packaging films.

There is therefore a need for a method of manufacture which is able to yield a thin packaging film comprising a low temperature sealing resin and which can be manufactured at reduced economical cost.

### SUMMARY OF THE INVENTION

The invention provides for a coextruded, low temperature sealing, biaxially oriented multilayer film structure, comprising a core layer and a sealant layer, having a seal initiation temperature of from 70 to 100° C. Preferably the combined thickness of the core and the sealant layer is 20 to 60 micrometers and the sealant layer has a thickness of from 10 to 20 percent based on the combined thickness of the core and sealant layer.

### BRIEF DESCRIPTION OF THE DRAWINGS

FIG. 1 shows a schematic view of a triple bubble, or 3B, process.

### DETAILED DESCRIPTION

The term “seal initiation temperature” refers to the minimal sealing temperature to which the jaws of a sealing apparatus, having a residence time of 0.8 seconds, must be heated in order to form a seal between two contacting sealing layers that will require a force of at least 1N/15 mm to fail adhesively. The term “seal initiation temperature” refers to the minimal sealing temperature to which the jaws of a sealing apparatus, e.g., having a residence short time of 0.1 to 2 or about 0.8 seconds, must be heated in order to form a seal between two contacting sealing layers that require a force of at least 1N/15 mm to fail adhesively. Failing adhesively means that the seal is not strong enough to sustain the peels or delamination force and can be peeled or delaminated below such force.

The invention provides for a coextruded, low temperature sealing, biaxially oriented multilayer film structure, comprising a core layer and a sealant layer having a seal initiation temperature of from 70 to 100° C., wherein the combined thickness of the core and the sealant layer is of from 20 to 60 μm, and the sealant layer has a thickness of from 10 to 20 percent based on the combined thickness of the core and sealant layer.

The multilayer film structure of the invention can be obtained via a so-called triple bubble process, in which the layers of the multilayer film structure can be coextruded through an annular die to form a tubular multilayer film structure. As will be described herein below, the tubular multilayer film structure is then stretched in the various stages of the 3B process into a coextruded, low temperature sealing, biaxially oriented multilayer film structure.

The 3B process allows to manufacture a coextruded, low temperature sealing, biaxially oriented multilayer film in one step and to circumvent the previously described steps of applying a sealing resin dispersion and drying the dispersion.

The coextruded, low temperature sealing, biaxially oriented multilayer film structure comprises a core layer that comprises at least one polyolefin which may be chosen from polymers of ethylene, propylene, butylene, and/or combinations thereof.

Preferably, the core layer comprises at least one polymer having a barrier to moisture, such as for example at least one polypropylene that may be chosen among homopolymers of propylene and copolymers of propylene with other alpha olefins.

Suitable alpha olefins are for example branched or unbranched C₃ to C₈ alpha olefins, and preferably the alpha olefin is butylene.

More preferably the core layer comprises at least one homopolymer of propylene having a melt flow index of from 1 to 8 g/10 min when measured according to ASTM D1238 at 230° C. using a weight of 2.16 kg.

Because the multilayer film structure of the invention may be obtained via a so-called triple bubble process, or 3B process, in which the layers of the multilayer film structure can be coextruded through an annular die to form a tubular multilayer film structure which is then biaxially oriented, the core layer comprised in the tubular multilayer film structure is also biaxially oriented.

This biaxial orientation not only enhances the mechanical properties of the core layer and concurrently those of the multilayer film structure as a whole, but also provides for an enhancement in barrier properties against moisture.

The coextruded, low temperature sealing, biaxially oriented multilayer film structure also comprises a sealant layer having a seal initiation temperature of from 70 to 100° C., preferably of from 70 to 90° C. or of from 80 to 90° C.

The sealant layer having a seal initiation temperature of from 70 to 100° C. may comprise sealant compositions comprising at least one polyolefin, polyamide, polyester, polyurethane, and/or combinations thereof, and more preferably comprises sealant compositions comprising at least one polyolefin.

Suitable polyolefins may be chosen from homopolymers of ethylene and copolymers of ethylene such as for example copolymers of ethylene with at least one C₃ to C₈ α,β-ethylenically unsaturated carboxylic acid, alkyl (meth)acrylate such as methyl-, ethyl- or butyl(meth)acrylate; vinyl acetate, and/or combinations thereof.

Examples of such polyolefins are metallocene polyethylene, very low density polyethylene, linear low density polyethylene, ethylene methyl(meth)acrylate, ethylene ethyl(meth)acrylate, ethylene butyl(meth)acrylate, ethylene methyl(meth)acrylate, ethylene vinyl acetate, ethylene (meth)acrylic acid copolymer and ionomers thereof.

Preferably, the polyolefin comprised in the sealant composition of the sealant layer is an ethylene ionomer which is a copolymer of ethylene with at least one C₃ to C₈ α,β-ethylenically unsaturated carboxylic acid, at least partially neutralized by one or more alkali metal, transition metal, or alkaline earth metal cations and optionally with at least one methyl-,ethyl- or butyl(meth)acrylate. Such copolymers of ethylene are also known under the designation of “ionomer”. Such ionomers are well known to one skilled in the art. Examples include SURLYN®, available from E.I. du Pont de Nemours and Company, Wilmington, Del., USA.

More preferably, the polyolefin or ionomer comprised in the sealant composition of the sealant layer is a copolymer of ethylene having an melt flow index of from 0.5 to 5, more preferably of from 0.5 to 3, most preferably of from 0.5 to 1.5, when measured according to ASTM D1238 at 190° C. using a weight of 2.16 kg.

The coextruded, low temperature sealing, biaxially oriented multilayer film structure, comprising a core layer and a sealant layer having a seal initiation temperature of from 70 to 100° C. may have a combined thickness of 20 to 60 micrometers, wherein the sealant layer may have a thickness of from 10 to 20 percent, based on the combined thickness of the core and sealant layer.

The sealant layer may have a thickness of from 10 to 20 percent, based on the combined thickness of the core and sealant layer, which equates to a thickness of from 2 to 12 micrometers.

Sealant layers having a thickness of from 2 to 12 micrometers have so far not been obtainable by lamination to or by coextrusion with a core layer, but only by coating a substrate film with sealant dispersions and are now obtainable via a so-called triple bubble process, or 3B process, in which the layers of the multilayer film structure, can be coextruded through an annular die to form a tubular multilayer film structure, which is then stretched and thinned in the various stages of the 3B process into a coextruded, low temperature sealing, biaxially oriented multilayer film structure of the invention.

The coextruded, low temperature sealing, biaxially oriented multilayer film structure comprising a core layer and a sealant layer may further comprise an ink receiving layer.

The ink receiving layer may comprise any suitable polymer capable of being printed, and may be chosen among the group of polyesters, thermoplastic polyurethanes, polyamides, and/or combinations thereof, and is preferably chosen among polyesters, polyamides and/or combinations thereof.

Suitable polyesters for the ink receiving layer may be chosen among aliphatic polyesters or semi-aromatic polyesters obtained by polycondenstaion of one or more suitable dicarboxylic acids and one or more suitable diols, or of one or more hydroxylated carboxylic acids.

Suitable dicarboxylic acids constituting the polyester may include terephthalic acid, isophthalic acid, phthalic acid, 5-tert-butylisophthalic acid, naphthalene dicarboxylic acid, diphenyl ether dicarboxylic acid, cyclohexane-dicarboxylic acid, adipic acid, oxalic acid, malonic acid, succinic acid, agelaic acid, sebacic acid, and dimer acids comprising dimers of unsaturated fatty acids, which may be used singly or in combination of two or more species.

Suitable diols constituting the polyester may include ethylene glycol, propylene glycol, tetramethylene glycol, neopentyl glycol, hexamethylene glycol, diethylene glycol, polyalkylene glycol, 1,4-cyclohexane-dimethanol, 1,4-butanediol, and 2-alkyl-1,3-propane diol which may be used singly or in combination of two or more species.

Examples of such polyesters are polyethylene terephthalate, polylactic acid, or PETG (glycol-modified polyethylene terephthalate; glycol monomer replaced by cyclohexane dimethanol (CHDM) to make it less crystalline, i.e. more amorphous).

Suitable polyamides for the ink receiving layer may be chosen from the group comprising aliphatic polyamides such as nylon 6, nylon 66, nylon 11, nylon 12, nylon 69, nylon 610 and nylon 612; aliphatic co-polyamides such as nylon 6/66, nylon 6/69, nylon 6/610, nylon 66/610, and nylon 6/12; and/or combinations thereof.

The coextruded, low temperature sealing, biaxially oriented multilayer film structure comprising a core layer and a sealant layer may further comprise other functional layers, such as for example tie layers, oxygen barrier layers, pigmented layers, which can be coextruded with the multilayer film structure, of the invention.

The multilayer film structure of the invention may be obtained via a so-called triple bubble process, or 3B process, in which the layers of the multilayer film structure, can be coextruded through an annular die to form a tubular multilayer film structure. As is described herein below, the tubular multilayer film structure can be then stretched in the various stages of the 3B process into a coextruded, low temperature sealing, biaxially oriented multilayer film structure.

The 3B process can be used for manufacturing a coextruded, low temperature sealing, biaxially oriented multilayer film structure. The process can comprise coextruding a core layer and an inner sealant layer using a circular die to form a tubular multilayer film structure. The coextruded tubular multilayer film structure can be cooled in a first bubble followed by biaxially orienting the tubular multilayer film structure in a second bubble.

The coextruded multilayer structure can be heated in the second bubble to a temperature between the glass transition temperature (of the polymer having the lowest transition temperature) and the melting point (of the polymer having the highest melting temperature). The orienting can be carried out at a temperature of from the glass transition point of the polymer material having the lowest glass transition point in the tubular coextruded multilayer film structure to the melting point of the highest melting material of the tubular coextruded multilayer film structure in a second bubble. The oriented multilayer can then be at least partially relaxed in a third bubble at a temperature of from the glass transition point of the material having the lowest glass transition point in the tubular coextruded multilayer film structure to the melting point of the highest melting material of the tubular coextruded multilayer film structure.

The above described triple bubble process allows for the manufacture of a coextruded, low temperature sealing, biaxially oriented tubular multilayer film structure having an inner sealant and an core layer. An exemplary description of such a 3B process is provided for example in WO2007099214.

Coextruding a core layer and an inner sealant layer using a circular die to form a tubular multilayer film structure may be carried out by connecting multiple extruders separately processing the corresponding layer materials, generally in the form of granulates, to a circular or annular die to form a tubular multilayer film structure.

The core layer polymer making up the corresponding layer in the tubular multilayer film structure of the invention can be fed into an extruder by methods known in the art such as to form the core layer of the tubular multilayer film structure upon passing through a circular die.

The sealant layer polymer making up the corresponding layer in the tubular multilayer film structure of the invention can be fed into an extruder by methods known in the art such as to form the inner sealant layer of the tubular multilayer film structure upon passing through a circular die.

In the case where the tubular multilayer film structure of the invention further comprises an ink receiving layer, the ink receiving layer polymer making up the corresponding layer in the tubular multilayer film structure of the invention can be fed into an extruder by methods known in the art such as to form the outermost layer of the tubular multilayer film structure upon passing through a circular die.

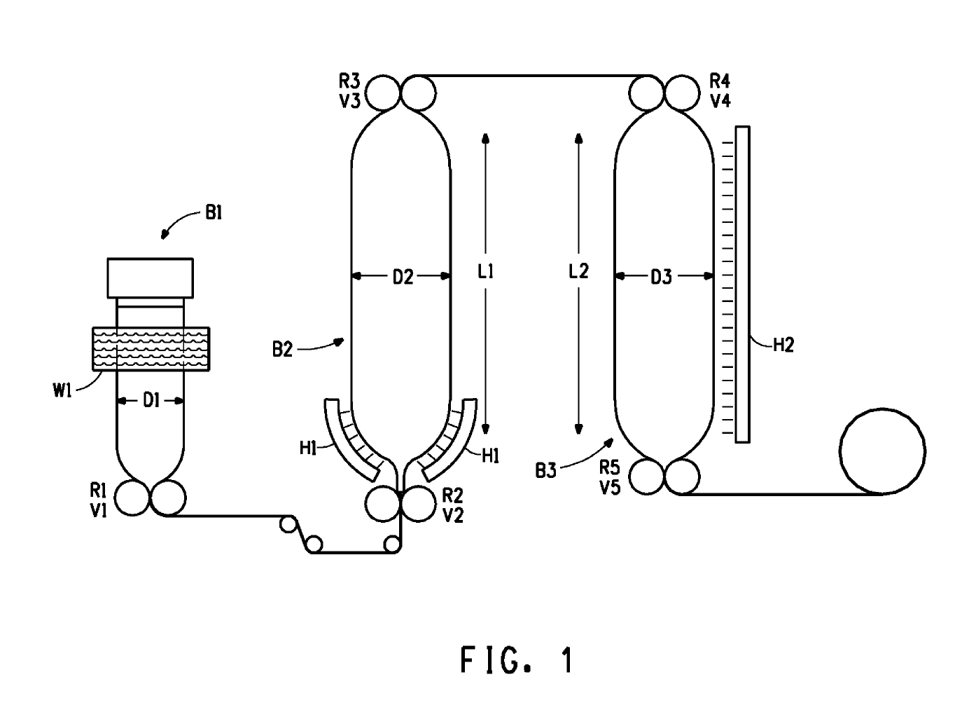

Referring to FIG. 1, the first bubble B1 of the triple bubble process is formed on one end by the tubular multilayer film having a diameter of D1 exiting the die, and on the other end by the set of rolls R1 that form the hermetically closed end of the first bubble B1.

In the first bubble B1, the tubular multilayer film structure exiting the die and having an initial diameter D1 is quickly cooled in a way such as to obtain a minimum amount of crystallization in the structure.

Said quick cooling is preferably obtained by quenching the exiting coextruded tubular multilayer film structure through a first water bath W1 having a temperature of from 0.1° C. to 50° C., more preferably of from 0.1° C. to 25° C. and a length of from 0.4 to 5 m, preferably of from 1 to 3 m. The residence time in the water quenching bath may be adjusted to range of from 1 to 20 seconds.

After passing through the set of flattening rolls R1, at an adjusted speed V1, the solidified coextruded tubular multilayer film structure may be preheated in a heated water bath at a temperature between 80° C. and 95° C. and is subsequently passed through a set of nip rolls R2, to be inflated and to form the second bubble B2.

Inflating allows for the tubular multilayer film structure to be drawn, or oriented, in both machine/axial direction (MD) and transverse/radial direction (TD), in the second bubble B2, at the same time to yield a biaxially oriented tubular multilayer film.

The drawing in the machine/axial direction (MD) can be achieved by adjusting the speed V2 of a second set of nip rolls R2 that form the upstream (towards the extruder) end of the second bubble and the speed V3 of a third set of nip rolls R3 that form the downstream (away from extruder) end of the second bubble. Generally, V3 is greater than V2, preferably 2 to 4 times greater than V2. Stated alternatively, the ratio given by V3/V2 is equivalent to the MD drawing ratio and is preferably of from 2 to 4.

The drawing in the transverse/radial direction (TD) can be achieved by adjusting the pressure P1 within the second bubble B2. To adjust the pressure P1, the distance L1 between a first set of nip rolls R2 that form the hermetically closed upstream (towards the extruder) end of the second bubble B2, and a second set of nip rolls R3 that form the hermetically closed downstream (away from extruder) end of the second bubble B2 can be adjusted. Reducing the distance L1 between the two sets of nip rolls (R2, R3) may increase the pressure P1 (not shown), whereas increasing the distance L1 may lower the pressure P1 within the second bubble. After the drawing in the transverse/radial direction (TD), the initial diameter D1 of the softened tubular multilayer film can be increased to a diameter D2, wherein the TD drawing ratio given by D2/D1 is of from 2 to 5, preferably of from 2.5 to 3.5.

A heat source H1 such as a hot air blower, steam, IR heater or heating coils is preferably located immediately after the second set of nip rolls R2 sealing the upstream (towards the extruder) end of the second bubble to warm up the expanding tubular coextruded multilayer film structure to a temperature of from the glass transition point of the material having the lowest glass transition point in the tubular coextruded multilayer film to the melting point of the highest melting material of the tubular coextruded multilayer film, preferably of from 50 C° to 200° C.

The biaxially oriented, tubular coextruded multilayer film structure is cooled by air surrounding the bubble before passing through the third set of nip rolls R3, where the tubular coextruded multilayer film structure is flattened to be more easily conveyed. After passing through the set of rolls R3, the tubular coextruded multilayer film structure is passed through a fourth set of nip rolls R4 that form the hermetically closed upstream (towards the extruder) end of the third bubble B3, and a fifth set of nip rolls R5 that form the hermetically closed downstream (away from extruder) end of the third bubble B3.

The fourth and fifth set of nip rolls (R4, R5) are separated by a distance L2 that can be adjusted to increase or decrease the pressure P2 (not shown in FIG. 1) within the third bubble B3 in order to allow the previously drawn tubular coextruded multilayer film structure to relax in transverse/radial direction (TD).

Generally, this can be achieved by adjusting the pressure P2 in the third bubble B3 such that the pressure P2 is lesser than the pressure P1. The pressure is adjusted by modifying the distance L2 between the fourth and the fifth set of nip rolls (R4, R5) of the third bubble B3. The lesser pressure P2 will allow the tubular multilayer film to relax to a diameter D3. The relaxation ratio is given by the ratio of D3/D2, whereas D3 is usually lesser than D2 and concurrently the ratio of D3/D2 is smaller than 1. Typically the ratio of D3/D2 can be of from 0.8 and 0.95, more preferably between 0.85 and 0.9.

The speed V4 of the fourth set of nip rolls R4 and the speed V5 of the fifth set of nip rolls may be adjusted in order to allow the previously drawn tubular coextruded multilayer film structure to relax in machine/axial direction (MD).

Generally, this can be achieved by adjusting the speed V5 of the fifth set of nip rolls R5 such that V5 is lesser than V4. The relaxation ratio is given by V5/V4, whereas V5 is usually lesser than V4 and concurrently the ratio of V5/V4 is smaller than 1. Typically the ratio of V5/V4 can be of from 0.8 to 0.95, more preferably of from 0.85 to 0.9.

The temperature of the tubular multilayer film structure in the third bubble, the pressure P2 and the ratio of V5/V4 may be adjusted individually or in parallel to achieve a tubular coextruded multilayer film structure exhibiting a thermal shrink of less than 15 percent or of from 5 to 15 percent, more preferably of less than 5 percent or of from 1 to 5 percent, when measured after exposure to a temperature of 85° C. for 10 seconds in a hot water bath, using a sample of 10×10 cm, in machine/axial direction (MD) and/or transverse/radial direction (TD).

The temperature of the tubular multilayer film structure in the third bubble can be adjusted by a heating device H2, such as for example an IR heater or heated air heater, hot water or steam, and can be chosen depending on the materials in the tubular coextruded multilayer film structure.

Generally, the temperature of the tubular multilayer film structure in the third bubble can be of from the glass transition point of the material having the lowest glass transition point in the tubular multilayer film structure to the melting point of the highest melting material of the tubular multilayer film structure with the proviso that the temperature of the tubular multilayer film structure in the third bubble is higher than the one of the tubular multilayer film structure in the second bubble.

Immediately before being flattened by passing through the fifth set of nip rolls R5, the tubular multilayer film in the third bubble may be optionally cooled by blown air, and can subsequently stored on a roll S.

Optionally, the tubular coextruded multilayer film exiting the fifth set of nip rolls R5 can be slit on one side by a slitting knife K to yield a planar coextruded multilayer film structure that can be stored on a roll S.

The above process provides for the manufacture of a coextruded, low temperature sealing, biaxially oriented multilayer film structure, comprising a core layer and a sealant layer having a seal initiation temperature of from 70 to 100° C., wherein the combined thickness of the core and the sealant layer is of from 20 to 60 micrometers, and wherein the a sealant layer has a thickness of from 10 to 20 percent based on the combined thickness of the core and sealant layer.

The above process provides for the manufacture of a coextruded, low temperature sealing, biaxially oriented multilayer film structure having a thermal shrink of no more than 15%, preferably of no more than 5% or between 1% and 5% when measured by immersion of a 10 x 10 cm sample into a water bath at a temperature of 85° C. for 10 seconds.

The coextruded multilayer film structure may be used in particular in packaging applications, more specifically in snack bars packed on high speed HFFS packaging machines.

The invention further provides for a packaging article comprising a coextruded, low temperature sealing, biaxially oriented multilayer film structure.

In particular, the packaging article may be used for the packaging of heat sensitive foods such as for example chocolate bars, frozen goods such as ice cream, dairy products such as butter.

The use of a coextruded, low temperature sealing, biaxially oriented multilayer film structure, comprising a core layer and a sealant layer having a seal initiation temperature of from 70 to 100° C. according to the invention allows for very short residence times in the heat sealing apparatus, because the low seal initiation temperature means that the sealing bars do not need to be heated up for a long time between two sealing steps. Also, the thinner gauge of the multilayer film of the invention will further reduce the time during which the sealing bars need to be closed on a sealing area to form a seal because of faster heat transfers compared to a thicker multilayer film.

### EXAMPLES

A multilayer tubular film having, from inside to outside and in this order, an ionomer layer, a tie layer, a PP layer, a tie layer and a PET layer, was coextruded on a Kuhne (St. Augustin, Germany) 3B line through a stacked circular die having a diameter of 100 mm by connecting five separate extruders containing the relative polymers to the die.

The ionomer is commercially available from E. I. du Pont de Nemours and Company (Wilmington, USA) under the trademark SURLYN® 1706 and has an melt flow index of 0.7 g/10 min when measured at 190C using a weight of 2.17 kg according to ASTM D1238. The tie layer polymer is commercially available from E. I. du Pont de Nemours and Company (Wilmington, USA) under the trademark BYNEL® 22E780.

The polypropylene is commercially available from Lyondell Basell Industries (Rotterdam, NL) under the trademark ADSYL® 6C30F.

The PET is commercially available from E. I. du Pont de Nemours and Company (Wilmington, USA) under the trademark APPEEL®93D894.

The exiting coextruded multilayer tubular film forming the first bubble, flowing vertically downward at a rate of 90 Kg/hr, was then directed through a cooling water bath having a temperature of 15° C. and was subsequently flattened by a pair of rubber rolls upon exiting the water bath after a residence time of 7 seconds. The flattened film was then conveyed into a heating water bath having a temperature of 92° C. for 5 seconds.

The flattened, heated film was then passed through hermetically sealed rolls forming the upstream end of a bubble and was inflated using pressurized air to form a second bubble.

The pressure of the air in the third bubble was adjusted such as to result in a stretch ratio in transverse direction (TD) of 3.5. The pressure inside the bubble was 8 bars and there was no way to measure it after closing the bubble with the nip R3

The velocities of the hermetically sealed rolls forming the upstream end of the second bubble and the hermetically sealed rolls forming the downstream end of the second bubble were adjusted such as to result in a stretch ratio in machine direction (MD) of 2.6. The velocity of the upstream stream rolls was 0.3 m/s and the velocity of the downstream rolls was 0.8 m/s

Before being flattened by the hermetically sealed rolls forming the downstream end of the second bubble, the coextruded multilayer tubular film was cooled down by a set of air blowers arranged circumferentially around the second bubble. After passing through the hermetically sealed rolls forming the downstream end of the second bubble an being flattened, the coextruded multilayer tubular film is passed through a set of rolls and is conveyed towards the hermetically sealed rolls forming the upstream end of the third bubble.

The flattened coextruded multilayer tubular film was then passed through hermetically sealed rolls forming the upstream end of the third bubble and was inflated using pressurized air to form a third bubble.

Immediately after passing through the hermetically sealed rolls forming the upstream end of the third bubble, the coextruded multilayer tubular film was heated by a set of air blowers arranged circumferentially around the second bubble and outputting hot air at a temperature of 300° C.

The pressure of the air in the third bubble was adjusted such as to result in a stretch ratio in transverse direction (TD) of 0.72.

The velocities of the hermetically sealed rolls forming the upstream end of the second bubble and the hermetically sealed rolls forming the downstream end of the third bubble were adjusted such as to result in a stretch ratio in machine direction (MD) of 0.95. The velocity of the upstream stream rolls was 0.8 m/s and the velocity of the downstream rolls was 0.75 m/s.

The coextruded multilayer tubular film was passed through the hermetically sealed rolls forming the downstream end of the third bubble to be flattened and was then slit to yield a coextruded multilayer film and wound up on a roll for storing.

In the thus obtained coextruded multilayer film having the structure PET/tie/PP/tie/Ionomer, the thicknesses of the individual layers were of 7 μm/3 μm/20 μm/3 μm/15 μm respectively.

The thus obtained coextruded multilayer film was then tested for seal strength by sealing the coextruded multilayer film to itself at different sealing temperatures.

15 mm wide film samples were cut out and sealed to themselves at different temperatures for 0.8 s and at a pressure of 0.1 MPa using a Kopp (Reichenbach, Germany) heat sealer model SGPE20 with 20 mm wide flat seal jaws and subsequently tested for seal strength on a Zwick (Ulm, Germany) 1435 tensile tester at a speed of 100 mm/min. 15 mm (breadth). Results are shown in Table 1.

TABLE 1

Seal jaw temperature
(in ° C.)

| | 90 | 100 | 110 | 130 |
|---|---|---|---|---|
| Seal strength (in N/15 mm) | 1 | 2.8 | 3 | 7 |

As can be seen from Table 1, the coextruded multilayer film obtained according to the above process has a seal initiation temperature of 90° C., meaning that at a sealing temperature of 90° C. the formed seal will require at least a force of 1N/15 mm to fail adhesively.

1. A multilayer comprising or produced from a core layer and a sealant layer wherein
the multilayer is a coextruded, biaxially oriented film or sheet;
the core layer comprises a polyolefin;
the sealant layer has a seal initiation temperature from 70 to 100° C.; seal initiating temperature refers to the minimal sealing temperature to which the jaws of a sealing apparatus, having a residence time of 0.8 seconds, must be heated in order to form a seal between two contacting sealing layers that require a force of at least 1N/15 mm to fail adhesively;
the sealant layer comprises or is produced from an ethylene ionomer, polyolefin, polyamide, polyester, polyurethane, or combinations of two or more thereof;
the combined thickness of the core and the sealant layer is 20 to 60 μm; and
the sealant layer has a thickness of 10 to 20% of the combined thickness of the core layer and sealant layer.

2. The multilayer of claim 1 wherein the sealant layer comprises the ethylene ionomer.

3. The multilayer of claim 2 wherein the core layer comprises at least one homopolymer of propylene having a melt index of 2 to 5.

4. The multilayer of claim 2 further comprising an ink receiving layer.

5. The multilayer of claim 3 further comprising an ink receiving layer.

6. The structure according to claim 5 wherein the at least one ink receiving layer is a polyester or a polyamide.

7. The multilayer of claim 2 further comprising an additional layer including tie layer, oxygen barrier layer, pigmented layer, or combinations or two or more thereof.

8. The multilayer of claim 7 wherein the core layer comprises at least one homopolymer of propylene having a melt flow index of from 2 to 5.

9. The multilayer of claim 8 wherein the additional layer is on the surface of the core layer.

10. The multilayer of claim 7 wherein the additional layer is an oxygen-barrier layer.

11. The multilayer of claim 8 wherein the additional layer is an oxygen-barrier layer.

12. The multilayer of claim 9 wherein the additional layer is an oxygen-barrier layer.

13. A process for manufacturing a coextruded, biaxially oriented multilayer film or sheet, comprising (1) coextruding a core layer polymer and a sealant layer polymer using a circular die to form a tubular multilayer, (2) cooling the tubular multilayer in a first bubble to a cooled multilayer, (3) biaxially orienting the cooled multilayer in a second bubble to an oriented multilayer and (4) at least partially relaxing the oriented multilayer in a third bubble wherein
the sealant layer is an inner layer;
the core layer comprises a polyolefin; and
the orienting, the relaxing, or both is carried out between the lowest glass transition temperature and the highest melting temperature where the lowest transition temperature refers to the glass transition temperature of polymer in the multilayer having the lowest glass transition temperature and the highest melting temperature refers to melting point of polymer in the multilayer having the highest melting point.

14. The process of claim 13 wherein the polyolefin is homopolymer of propylene having a melt index of 2 to 5 and the sealant layer comprises or is produced from an ethylene ionomer, polyolefin, polyamide, polyester, polyurethane, or combinations of two or more thereof.

15. The process of claim 14 wherein the sealant layer comprises or is the ethylene ionomer.

16. The process of claim 15 further comprising coextruding an additional layer polymer including tie layer, oxygen barrier layer, pigmented layer, or combinations or two or more thereof.

17. The process of claim 16 wherein the additional layer is on the surface of the core layer.

18. The process of claim 17 wherein the additional layer is an oxygen-barrier layer.
